(19) United States
(12) Patent Application Publication
(10) Pub. No.: US 2017/0058804 A1
(43) Pub. Date: Mar. 2, 2017

(54) Engine Control Method and Engine Control System

(71) Applicants: Hyundai Motor Company, Seoul (KR); KIA Motors Corporation, Seoul (KR)

(72) Inventor: Hyun KIM, Hwaseong-si (KR)

(73) Assignees: Hyundai Motor Company; KIA Motors Corporation

(21) Appl. No.: 14/956,092

(22) Filed: Dec. 1, 2015

(30) Foreign Application Priority Data
Aug. 26, 2015 (KR) 10-2015-0120390

(51) Int. Cl. F02D 41/02; F01N 13/00; F02D 41/00; F01N 3/10

(52) U.S. Cl. CPC F02D 41/0235; F01N 3/10; F01N 13/008; F02D 41/0087; F01N 2900/1811

(57) ABSTRACT

An engine control system may include an engine including first and second banks, each of which includes a plurality of cylinders, first and second CDA devices provided to selectively deactivate the respective cylinders of the first or second bank, a first catalyst connected with the first bank, and a second catalyst connected with the second bank, a temperature measurer measuring a temperature of one of the first and second catalysts connected with a bank of which a CDA device among the first and second CDA devices is deactivated while one of the first and second CDA devices is being activated, and an engine controller deactivating an activated CDA device among the first and second CDA devices and activates the other CDA device when the measured temperature of the catalyst is higher than or equal to a reference temperature.

### CROSS-REFERENCE TO RELATED APPLICATION

This application claims priority to Korean Patent Application No. 10-2015-0120390, filed on Aug. 26, 2015, the entire contents of which are hereby incorporated by reference.

### FIELD

The present disclosure relates an engine control method and an engine control system. More particularly, the present disclosure relates to an engine control method and an engine control system that can be used to control an engine installed in a vehicle.

### BACKGROUND

A cylinder de-activation (CDA) engine is a variable cylinder combust control technical, and reduces fuel consumption by controlling combustion of a cylinder according to an engine operation state. An output is maximized through combustion of all cylinders in a high-output high-acceleration condition, and combustion of a partial cylinder is stopped in a low load area through CDA operation to thereby improve fuel consumption.

A pumping loss occurred during intake and exhaust from the CDA operation of the engine may be reduced by more than or equal to about 50%, and accordingly, vehicle fuel consumption may be reduced by about 5% to 15%. Recently, a CDA method has been actively developed and researched for enhancement of fuel consumption and a bank-specific CDA method that is advantageous to a V-type engine in cost and control has been considered.

Purification of an exhaust gas, a three way catalyst may be applied. The catalyst should operate in a constant temperature condition for maintaining purification efficiency of the exhaust gas. When a temperature of the catalyst is too low, purification efficiency is deteriorated, and when the temperature of the catalyst is too high, the catalyst is damaged by the heat, thereby causing melting of the catalyst. Thus, a catalyst overheating protection (COP) logic is applied to a general engine, and in case of a CDA engine, the temperature of the catalyst is excessively decreased.

When the catalyst temperature is increased, a COP logic is performed for catalyst protection, and when the catalyst temperature is increased to be higher or equal to a predetermined temperature, the COP logic is operated and thus much more fuel is sprayed to decrease the catalyst temperature. That is, when the COP logic operates, fuel is additionally sprayed to decrease a catalyst temperature, thereby increasing fuel consumption.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to provide an engine control method and an engine control system for improving fuel consumption.

An engine control system according to one aspect of the present disclosure may include: an engine including first and second banks, each of which a plurality of cylinders are formed, first and second CDA devices provided to selectively deactivate the respective cylinders of the first or second bank, a first catalyst connected with the first bank, and a second catalyst connected with the second bank; a temperature measurer measuring a temperature of one of the first and second catalysts connected with a bank of which a CDA device among the first and second CDA devices is deactivated while one of the first and second CDA devices is being activated; and an engine controller deactivating an activated CDA device among the first and second CDA devices and activates the other CDA device when the measured temperature of the catalyst is higher than or equal to a reference temperature.

The reference temperature may be included in a range of 850° C. to 900° C.

The engine controller may control the temperature measurer to continuously measure a temperature of the catalyst when the measured temperature of the catalyst below the reference temperature.

According to another exemplary form of the present disclosure, a method is provided to control an engine including first and second banks, each of which a plurality of cylinders are formed, first and second CDA devices provided to selectively deactivate the respective cylinder of the first or second bank, a first catalyst connected with the first bank, and a second catalyst connected with the second bank. The method may include: while one of the first and second CDA devices is being activated, measuring a temperature of one of the first and second catalysts, connected with a bank of which a deactivated CDA; determining whether the measured temperature of the catalyst is higher than or equal to a reference temperature; and when the measured catalyst temperature is higher than or equal to the reference temperature, deactivating an activated CDA device among the first and second CDA devices and activating the other CDA device.

In the determining of the catalyst temperature, the measuring of the catalyst temperature may be performed again when the measured catalyst temperature is below the reference temperature.

The reference temperature may be included in a range of 850° C. to 900° C.

The engine control method according to the exemplary form of the present disclosure performs bank conversion rather than performing a COP logic when a temperature of a catalyst starts to increase to be higher than or equal to a reference temperature.

Accordingly, the catalyst temperature can be controlled to be lower than a predetermined temperature and thus fuel consumption due to execution of the COP logic can be prevented, thereby enabling enhancement of fuel consumption.

### DRAWINGS

FIG. 1 is a schematic diagram of a combustion chamber and a bank of an engine that can adopt an engine control method.

FIG. 2 is a schematic diagram of an engine control system.

FIG. 3 is a flowchart of the engine control method.

FIG. 4 is a graph illustrating two banks converted as time lapses in the engine control method.

### DETAILED DESCRIPTION

The present disclosure will be described more fully hereinafter with reference to the accompanying drawings, in which exemplary forms of the disclosure are shown. As those skilled in the art would realize, the described forms may be modified in various different ways, all without departing from the spirit or scope of the present disclosure.

Accordingly, the drawings and description are to be regarded as illustrative in nature and not restrictive. Like reference numerals designate like elements throughout the specification.

In addition, in several exemplary forms, components having the same configuration will be representatively described using the same reference numerals in an exemplary form, and only components different from those of an exemplary form will be described in the other exemplary forms.

Throughout the present specification, when any one part is referred to as being “connected to” another part, it means that any one part and another part are “directly connected to” each other or are “indirectly connected to” each other with the other part interposed therebetween. In addition, unless explicitly described to the contrary, the word “comprise” and variations such as “comprises” or “comprising”, will be understood to imply the inclusion of stated elements but not the exclusion of any other elements.

An engine to which an engine control method according to an exemplary form of the present disclosure can be applied will be described before describing the engine control method according to the exemplary form of the present disclosure.

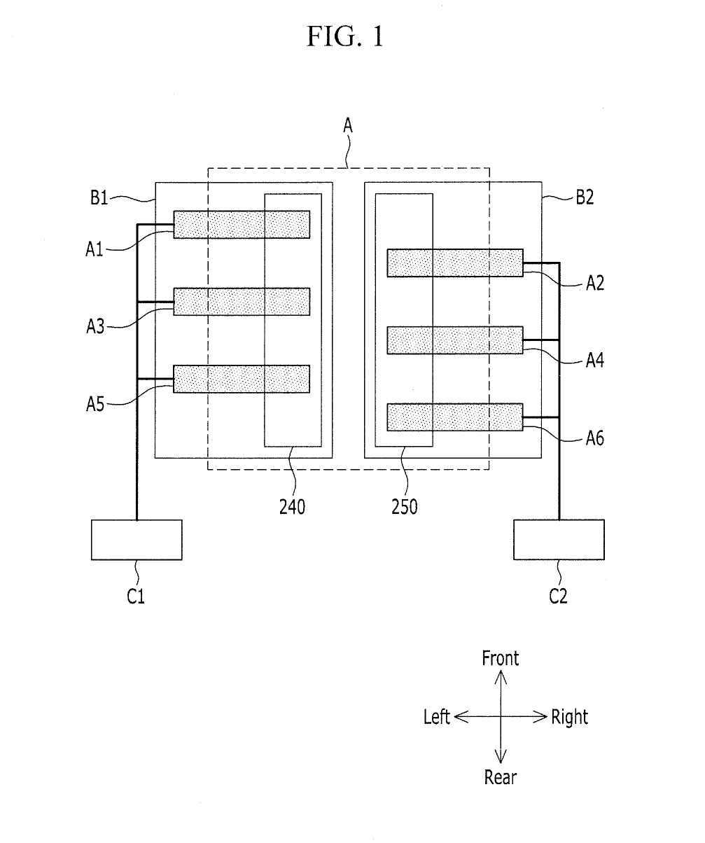

FIG. 1 is a schematic diagram of a combustion chamber, a bank, and a catalyst of an engine to which an engine control method.

Referring to FIG. 1, the engine control method can be applied to a V-type engine.

The engine shown in FIG. 1 is a 6-cylinder engine among various V-type engines. The 6-cylinder V-type engine includes six cylinders A, and three cylinders may be provided in each of the left and right sides. The engine is not limited to the 6-cylinder V-type engine, and the engine control method can be applied to various V-type engines such as an 8-cylinder V-type engine, a 12-cylinder V-type engine, and the like. In the 8-cylinder V-type engine, four cylinders may be provided in each of the left and right sides, and in the 12-cylinder V-type engine, six cylinders may be provided in each of the left and right sides.

For better comprehension and ease of description, it will be described in the 6-cylinder V-type engine that a first cylinder A1, a second cylinder A2, a third cylinder A3, a fourth cylinder A4, a fifth cylinder A5, and a sixth cylinder A6 are sequentially disposed from a front side to a rear side.

The first cylinder A1, the third cylinder A3, and the fifth cylinder A5 are formed in a first bank B1, and the first bank B1 may be connected with a first catalyst C1.

In addition, the second cylinder A2, the fourth cylinder A4, and the sixth cylinder A6 are formed in a second bank B2, and the second bank B2 may be connected with a second catalyst C2.

Thus, an exhaust gas discharged from each cylinder of the first bank B1 passes through the first catalyst C1, and an exhaust gas discharged from each cylinder of the second bank B2 passes through the second catalyst C2. The exhaust gases passed through the first catalyst C1 and the second catalyst C2 are mixed and then discharged to the outside of the vehicle through a tail pipe.

A first CDA device 240 that can deactivate the first cylinder A1, the third cylinder a3, and the fifth cylinder A5 is provided in the first bank B1, and a second CDA device 250 that can deactivate the second cylinder A2, the fourth cylinder A4, and the sixth cylinder A6 is provided in the second bank B2.

Hereinafter, an engine control system according to the exemplary form of the present disclosure will be described in detail.

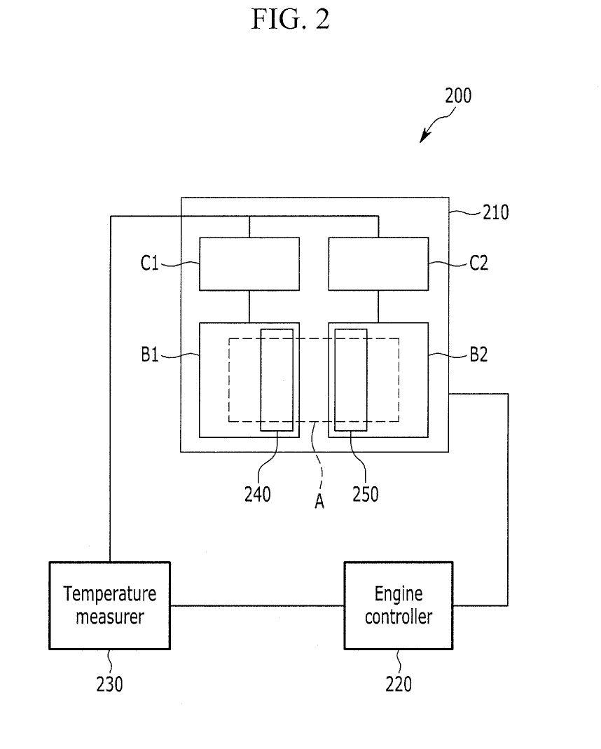

FIG. 2 is a schematic diagram of an engine control system.

Referring to FIG. 2, an engine control system 200 includes an engine 210, a temperature measurer 230, and an engine controller 220.

The engine 210 may include the plurality of cylinders A, the first bank B1, the second bank B2, the first catalyst C1, and the second catalyst C2.

While one of the first CDA device 240 and the second CDA device 250 is in an activated state, the temperature measurer 230 measures a temperature of one catalyst among the first catalyst C1 and the second catalyst C2, connected with a bank of which the CDA device is deactivated.

Here, activation of the CDA device implies a state that no fuel spray and combustion of the corresponding cylinder occur, and in this case, the corresponding bank is in the deactivated state.

On the contrary, deactivation of the CDA device implies a state that fuel spray and combustion of the corresponding cylinder are normally performed, and in this case, the corresponding bank is in the activated state.

When a temperature measured by the temperature measurer 230 is higher than or equal to a predetermined temperature, the engine controller 220 activates one of the activated bank among the two banks B1 and B2, that is, activates a CDA device of one of banks of which a CDA device is deactivated among the first and second CDA devices 240 and 250 and deactivates a CDA device of the other bank. Here, the reference temperature may be between 850° C. to 900° C.

Meanwhile, the engine controller 220 controls the temperature measurer 230 to continuously measure a temperature of the catalyst when the measured temperature of the catalyst is below the reference temperature.

An operation process of the engine control system 200 formed with such a structure according to the exemplary form of the present disclosure will be described in detail in description of the engine control method.

In the engine control system 200, the engine controller 220 deactivates an activated bank among the two banks B1 and B2 and activates the other deactivated bank when the temperature of the catalyst is higher than or equal to the reference temperature. That is, a catalyst temperature can be controlled to be lower than a constant temperature by performing bank conversion rather than performing a COP logic. Accordingly, fuel consumption due to execution of the COP logic can be prevented, thereby enabling enhancement of fuel consumption.

Hereinafter, an engine control method according to an exemplary form of the present disclosure will be described in detail.

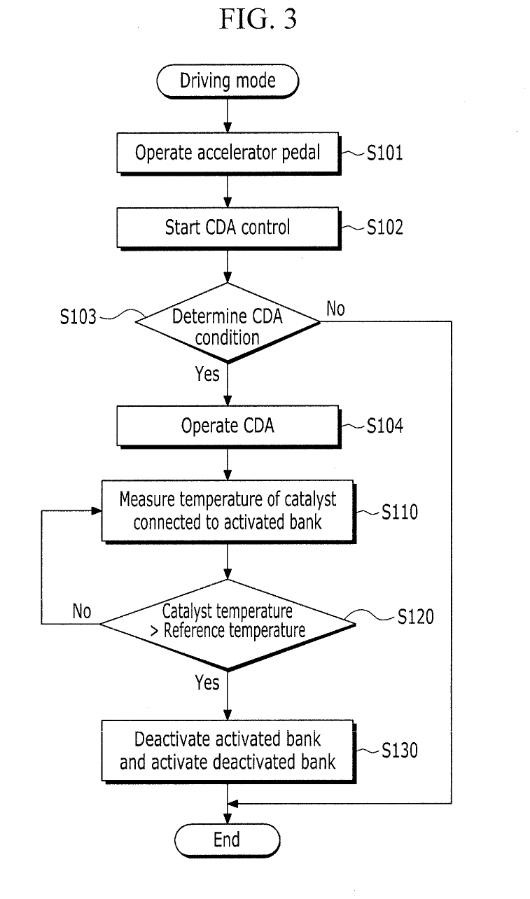

FIG. 3 is a flowchart of an engine control method.

Referring to FIG. 3, an engine control method according to the exemplary form of the present disclosure includes measuring a temperature of a catalyst connected to an activated bank (S110), determining whether the measured catalyst temperature is higher than or equal to a reference temperature (S120), and converting banks to deactivate the activated bank and activate a deactivated bank when the measured catalyst temperature is higher than or equal to the reference temperature (S130).

Before start to describe the measuring of the catalyst temperature (S110), a process performed prior to the measuring of the catalyst temperature (S110) will be described first.

First, as an acceleration pedal operates (S101), control of the first CDA device 240 and the second CDA device 250 is started (S102). Next, it is determined whether the current state is in a CDA condition while an engine operates (S103). As a method for determining the CDA condition, a method for determining a CDA condition in a general CDA engine can be used, and therefore no further description will be provided.

When it is determined to be the CDA condition in the determining the CDA condition (S103), one of the first CDA device 240 and the second CDA device 250 starts to operate (S104). A bank provided with an activated CDA device among the first CDA device 240 and the second CDA device 250 is in a deactivated state, and the other bank is in an activated state.

For example, in case of the above-stated 6-cylinder V-type engine, the first bank provided with the first cylinder, the third cylinder, and the fifth cylinder is in the activated state. In this case, combustion is performed in the first cylinder, the third cylinder, and the fifth cylinder. In addition, the second bank provided with the second cylinder, the fourth cylinder, and the sixth cylinder is in the deactivated state. In this case, all of the second cylinder, the fourth cylinder, and the sixth cylinder may be deactivated.

In such a CDA operation (S104) state, no combustion occurs in cylinders of the corresponding bank and thus fuel consumption can be reduced, thereby enabling enhancement of fuel consumption.

In such a state, measuring of the catalyst temperature (S110) is performed to measure a temperature of a catalyst connected to the activated bank. In this case, a method for measuring a temperature of a catalyst includes, for example, a method for measuring a temperature by installing a sensor in an exhaust pipe connecting catalysts or a catalyst and a bank or a method for acquiring a temperature of a catalyst by modeling the temperature of the catalyst. Such a method is a general method for measuring a temperature of a catalyst provided in a bank, and therefore no further detailed description will be provided.

Next, it is determined whether the measure catalyst temperature is higher than or equal to the reference temperature (S120). In the determining of the catalyst temperature (S120), the measured catalyst temperature and the reference temperature are compared to determine whether the catalyst temperature is higher than or equal to the reference temperature.

The reference range for comparison with the catalyst temperature may be included in a ranged between 850° C. to 900° C. The reference temperature may be a temperature before overheating of the catalyst and may be a temperature before execution of the COP logic. Unlikely, when the reference temperature is set to be higher than 900° C., a catalyst temperature is higher than or equal to 900° C. such that the COP logic is executed, thereby causing increase of fuel consumption.

However, in the engine control method, when a temperature of a catalyst is higher than the reference temperature (e.g., 900° C.), an activated bank connected with the corresponding catalyst is immediately deactivated. Then, the temperature of the catalyst is decreased and thus the COP logic is not executed. Accordingly, the increase of fuel consumption can be prevented.

In the determining of the catalyst temperature (S120), when the measured catalyst temperature is lower than the reference temperature, the determining of the measuring of the catalyst temperature (S110) may be performed again. That is, when the measured catalyst temperature is lower than the reference temperature, the measuring of the catalyst temperature (S110) may be iteratively performed.

In the determining of the catalyst temperature (S120), when the measured catalyst temperature is higher than or equal to the reference temperature, bank conversion (S130) is performed to deactivate the activated bank and activate a deactivated bank. That is, in the bank conversion (S130), an activated bank and a deactivated bank are converted.

For example, when the bank conversion (S130) is performed if the second bank is in the activated state and the first bank is in the deactivate state, the second bank is deactivated and the first bank is activated. In this case, the second cylinder, the fourth cylinder, and the sixth cylinder provided to the second bank are all deactivated, and combustion is started in the first cylinder, the third cylinder, and the fifth cylinder provided to the first bank.

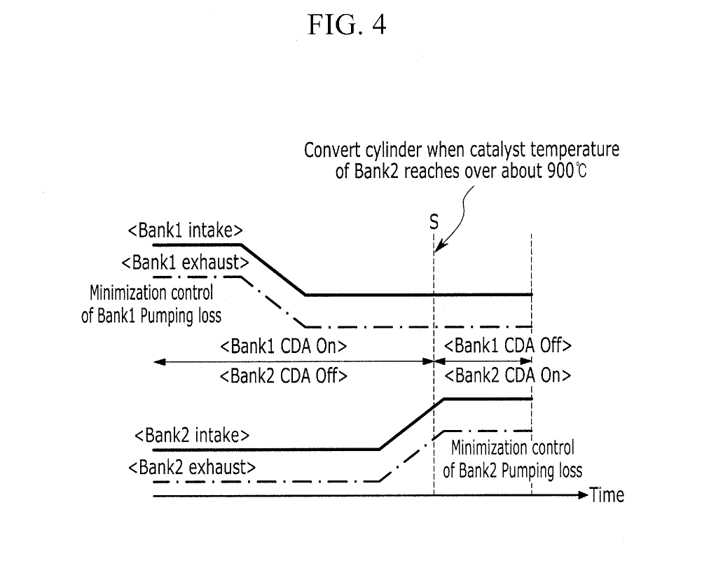

FIG. 4 is a graph illustrating conversion of two banks as time lapses in the engine control method according to the exemplary form of the present disclosure.

Referring to FIG. 4, as shown in the left side with reference to the line S, Bank1 is deactivated and thus the first CDA device 240 is activated (On), and Bank2 is activated and thus the second CDA device 250 is deactivated (Off).

When a predetermined time lapses after activation of Bank2, a temperature of the second catalyst C2 reaches 900° C. at a point.

In this case, as shown in the right side with reference to the line S, bank conversion is performed. Thus, Bank2 is deactivated and thus CDA function is performed (i.e., On), and Bank1 is activated and thus no CDA function is performed (i.e., Off). In addition, the temperature of second catalyst C2 is decreased below 900° C.

As described, the engine control method according to the exemplary form of the present disclosure performs the bank conversion rather than performing the COP logic when a temperature of a catalyst starts to be higher than or equal to a reference temperature.

Accordingly, since a temperature of a catalyst can be controlled to be lower than a predetermined temperature, fuel consumption due to execution of COP logic can be prevented, thereby acquiring a significant amount of engine consumption gain.

The drawings referred to in the above and disclosed detailed description of the present disclosure only illustrate the present disclosure, and are intended to describe the present disclosure, not to restrict the meanings or limit the scope of the present disclosure claimed in the claims. Therefore, those skilled in the art can understand that various modifications and other equivalent exemplary form may be made therefrom. Accordingly, the true technical protection scope of the present disclosure must be determined by the technical spirit of the accompanying claims.

What is claimed is:

1. An engine control system comprising:
an engine including first and second banks, each of which including a plurality of cylinders, first and second cylinder de-activation (CDA) devices configured to selectively deactivate the respective cylinders of the first or second bank, a first catalyst connected with the first bank, and a second catalyst connected with the second bank;
a temperature measurer configured to measure a temperature of one of the first and second catalysts connected with a bank of which one of the first and second CDA devices is deactivated while the other one of the first and second CDA devices is being activated; and
an engine controller configured to deactivate an activated CDA device among the first and second CDA devices and activate the other CDA device when the measured temperature of the catalyst is higher than or equal to a reference temperature.

2. The engine control system of claim 1, wherein the reference temperature is in a range of 850° C. to 900° C.

3. The engine control system of claim 1, wherein the engine controller is configured to control the temperature measurer to continuously measure a temperature of the catalyst when the measured temperature of the catalyst below the reference temperature.

4. A method for controlling an engine including first and second banks, each of which including a plurality of cylinders, first and second CDA devices configured to selectively deactivate the respective cylinders of the first or second bank, a first catalyst connected with the first bank, and a second catalyst connected with the second bank, comprising:
while one of the first and second CDA devices is being activated, measuring a temperature of one of the first and second catalysts, connected with a bank of which CDA is deactivated;
determining whether the measured temperature of the catalyst is higher than or equal to a reference temperature; and
when the measured catalyst temperature is higher than or equal to the reference temperature, deactivating an activated CDA device among the first and second CDA devices and activating the other CDA device.

5. The method for controlling the engine of claim 4, wherein the determining whether the measured temperature of the catalyst is higher than or equal to a reference temperature comprises measuring the catalyst temperature again when the measured catalyst temperature is below the reference temperature.

6. The method for controlling the engine of claim 4, wherein the reference temperature is in a range of 850° C. to 900° C.
